(19) United States
(12) Patent Application Publication
(10) Pub. No.: US 2005/0172130 A1
(43) Pub. Date: Aug. 4, 2005

(54) Watermarking a digital object with a digital signature

(76) Inventor: David Keith Roberts, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/508,564

(22) PCT Filed: Feb. 27, 2003
(86) PCT No.: PCT/IB03/00813

(30) Foreign Application Priority Data
Mar. 27, 2002 (EP) 02076199.5

(51) Int. Cl. H04L 9/00

(52) U.S. Cl. 713/176

(57) ABSTRACT

A method of protecting a digital object (111) against unauthorized tampering, comprising computing a digital signature over the contents of the digital object (111), creating a summary of the computed digital signature, and embedding the summary in the digital object (111). The authenticity of the thusly protected digital object (111) can be verified by extracting the embedded summary from the digital object (111), computing a digital signature over the contents of the digital object (111), creating a summary of the computed digital signature, and matching the extracted summary and the created summary, whereby the digital object (111) is verified as authentic if the matching is successful. Also devices and computer programs for implementing the protecting and verification methods.

The invention relates to a method of and a device for protecting a digital object against unauthorized tampering, in which a digital signature is computed as evidence of the authenticity of the digital object. The invention further relates to a method of and a device for verifying the authenticity of a digital object.

It is well known that digital objects such as images, sound recordings, audio- and/or video streams and so on can easily be altered without detectable traces being left behind in the digital objects. Such an alteration, when performed by an unauthorized entity, is often referred to as tampering with the digital object. The ease with which such digital objects may be tampered with creates a need for means allowing authentication of a digital object. Digital signatures are often used for this purpose.

The property that all signature generation methods having common, is that the signature size increases rapidly with the desired level of protection. That is, in order to detect even the smallest alterations to the objects, a digital signature comprising a large number of bits needs to be computed. This usually does not pose a problem in situations where the signature itself can be stored and/or transmitted to an entity wishing to verify the authenticity of the digital objects.

However, if the signature information is available separately, an unauthorized entity could still redistribute the tampered digital object in places where a recipient cannot easily obtain the signature information. To overcome this problem, the signature information can be embedded into the image as the payload of a watermark. The information should be embedded using robust watermarking technology, which means that it cannot be easily removed or altered.

Such robust watermarking techniques have the disadvantage that they can only accommodate a small number of payload bits relative to the size of the digital object. This means that it is very difficult to include reliable signature information (allowing detection of even small alterations) using robust watermarking technology in a digital object.

It is an object of the invention to provide a method of protecting a digital object against unauthorized tampering, which overcomes the above-mentioned difficulty.

This object is achieved according to the invention in a method comprising computing a digital signature over the contents of the digital object, creating a summary of the computed digital signature, and embedding the summary in the digital object. As the output of the summary function, preferably realized as a cryptographic hash function or cyclic redundancy check, will have a smaller number of bits than the digital signature, there are fewer bits that need to be embedded in the digital object. These bits can then be embedded using robust watermarking technology.

However, a property of these summary functions is that even relatively minor changes to their input results in very large changes in the summaries. Thus, an alteration to the digital object that results in an even slightly different digital signature, also results in a different summary being created. A verifier will thus be able to detect such alterations.

Functions such as cryptographic hashes or CRC functions are many to one mappings. This means that the same summary may be created for multiple different signatures. This in turn leads to an increase in the “false positive” rate, i.e. the probability that a tampered digital object is being judged erroneously as authentic increases. Consideration of the probability of such a false positive is required when choosing the digital signature function and summary function to be used. With careful design, the probability that a tampered object happens to result in the same summary as the original digital object can be maintained at an extremely low level.

Preferably, the digital signature is created by applying a robust hash function to the contents. This has the advantage that small changes to the digital object, such as conversion of the digital object from one format to another, or applying a lossy compression scheme to the digital object, will not result in a different digital signature. A thusly converted or compressed digital object will then still be judged authentic by a verifier. Note that alterations to the contents of the digital object itself will result in a different robust hash.

In an embodiment respective digital signatures are computed over respective portions of the contents, respective summaries are computed for the respective digital signatures, and the respective summaries are embedded in the respective portions. This embodiment provides the ability to detect which areas of a tampered digital object have been altered. For example, in the case of a digital image, the image could be divided into respective spatial regions, and respective digital signatures could be computed for each region. Checking is then similarly performed on the individual spatial regions.

It is a further object of the invention to provide a method of verifying the authenticity of a digital object, which can detect tampering with the object with fewer verification information.

This object is achieved according to the invention in a method comprising extracting verification information from the digital object, computing a digital signature over the contents of the digital object, creating a summary of the computed digital signature, and matching the verification information and the summary, whereby the digital object is verified as authentic if the matching is successful. The summary of a digital signature of the original digital object has been embedded previously in the digital object. As noted above, the summary will be smaller in terms of bits than the complete digital signature. However, since the summary directly depends on the digital signature, and any changes in the digital signature invariably result in a different summary, tampering with the object can still be detected even with only the information from the summary available.

Preferably an unreliable portion of the computed digital signature is adjusted upon an unsuccessful matching, after which the method is repeated using the adjusted digital signature. This way, unreliable portions of the digital signature are less likely to influence the verification method.

It is a further object of the invention to provide a device for protecting a digital object against unauthorized tampering, which overcomes the difficulty of the prior art.

This object is achieved according to the invention in a device comprising signature computation means for computing a digital signature over the contents of the digital object, summarizing means for creating a summary of the computed digital signature, and embedding means for embedding the summary in the digital object.

It is a further object of the invention to provide a device for verifying the authenticity of a digital object, which can detect tampering with the object with fewer verification information.

This object is achieved according to the invention in a device comprising extracting means for extracting verification information from the digital object, signature computation means for computing a digital signature over the contents of the digital object, summarizing means for creating a summary of the computed digital signature, and matching means for matching the verification information and the summary, whereby the matching means are arranged for verifying the digital object as authentic if the matching is successful.

It is a further object of the invention to provide a computer program product arranged for causing a processor to execute the protection method of the invention. It is a yet further object of the invention to provide a computer program product arranged for causing a processor to execute the verification method of the invention.

These and other aspects of the invention will be apparent from and elucidated with reference to the embodiments shown in the drawings, in which:

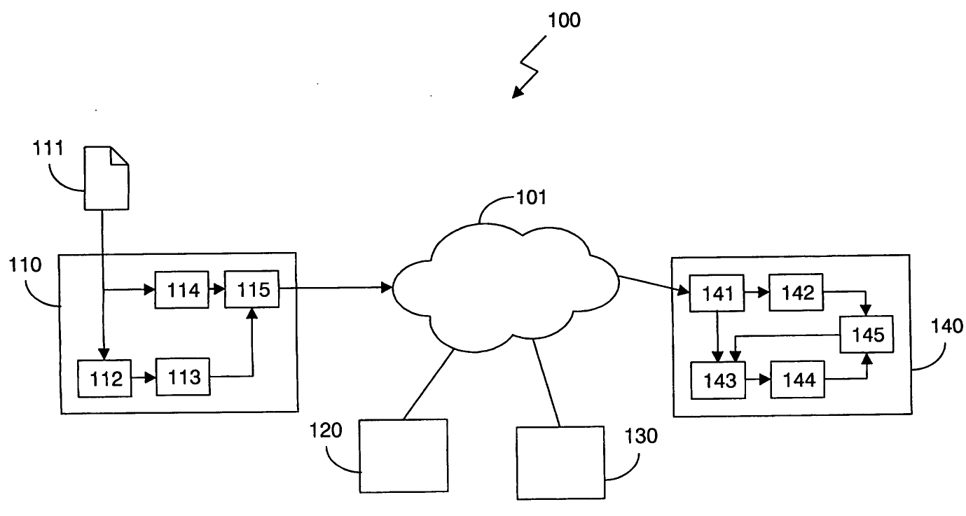

FIG. 1 schematically shows a system comprising a plurality of devices interconnected via a network.

FIG. 1 schematically shows a system 100 comprising a plurality of devices 110, 120, 130 and 140, interconnected via a network 101. The network 101 could be for instance the Internet or any other communication network, or a combination of different communication networks. Some of the features indicated in the drawing are typically implemented in software, and as such represents software entities, such as software modules or objects.

Device 110 wants to make an image 111 available to the other devices 120, 130 and 140, in such a way that these other devices 120, 130 and 140 can verify the authenticity of the image 111. For instance, device 110 could be a digital camera with which the image 111 was created. The device 110 could also comprise a computer system on which graphics editing software is running, whereby the image 111 then represents output of that software which needs to be protected against tampering.

To this end, the image 111 is fed to a signature computation module 112 which for computes a digital signature over the contents of the image 111. Preferably the digital signature is created by applying a robust hash function to the contents. When using a robust hash function or robust digital signature function, small changes to the digital object, such as conversion of the digital object from one format to another, or applying a lossy compression scheme to the digital object, will not result in a different digital signature. A thusly converted or compressed digital object will then still be judged authentic by a verifier. Note that alterations to the contents of the digital object itself, as opposed to its format, encoding or compression level and so on, will result in a different robust hash.

Several methods of computing a (robust) digital signature over the contents of the digital object are disclosed in, for example, M. Schneider, S. Chang, “A Robust Content Based Digital Signature For Image Authentication”, Proc. ICIP 1996, Laussane, Switzerland, October 1996, in C-Y. Lin, S-F. Chang, “Generating Robust Digital Signature For Image/Video Authentication”, Multimedia and Security Workshop at ACM Multimedia 1998, Bristol England, September 1998 or in M. P. Queluz, “Content Based Integrity Protection of Digital Images”, SPIE Conf. on Security and Watermarking of Multimedia Contents, San Jose, January 1999. Of course many other methods also exist, and those can easily be substituted.

The computed digital signature is subsequently fed to summarizing module 113. The module 113 creates a summary of the computed digital signature using a cryptographic hash function or cyclic redundancy check (CRC) function. The output of this function will typically be in the order of 128-160 bits for a cryptographic hash function or 32 bits for a CRC function. This is a substantial reduction in size compared to the output of the digital signature function, which usually is in order of several kilobytes. Cryptographic hash functions and CRC functions are well-known in the literature, see for example chapter 9 of Menezes et al. Handbook of Applied Cryptography, CRC Press 1996.

The digital image 111 and the summary are then fed to embedding module 114 where the summary is embedded in the digital object using watermarking technology. Embedding data in objects using watermarking is well known in the art and will not be elaborated on further. It is preferred that the watermarking technology used provide a so-called robust watermark, which is difficult or impossible to remove. Robust watermarks typically can carry only a limited payload, but output of the summarizing module 113 should be small enough to be accommodated by the robust watermarking scheme.

The image with embedded summary can then be distributed to third parties, for example by making it available on the network 101 using Web server software 115 or by e-mailing it to those third parties. Of course many other ways to distribute the image also exist.

Now, assume that device 140 at some point in time receives a specimen of the digital image 111 and wishes to verify the authenticity of this specimen. Generally speaking, the device 140 cannot be sure that the specimen it receives has not been modified after device 110 made it available. Unauthorized third parties could have obtained copies of the image 111, tampered with it and made the tampered version available on the network 101, or in another location where device 140 could obtain it. For instance, a hacker operating from device 120 could compromise the security of the Web server 115 and tamper with the image 111 as it is made available on the server 115. A malicious entity on device 130 could be in a position to tamper with the image 111 as it is being transmitted over the network 101, or run its own Web server software to make a tampered version of the image available. Tampered versions can of course be created and made available through a variety of means.

An extracting module 142 in the device 140 extracts the verification information from the specimen received using networking module 141. This verification information corresponds to the summary embedded in the image 111 in the device 110. Extracting this information can be done using conventional techniques for extracting information embedded in digital data using watermarking technology.

A signature computation module 143 computes a digital signature over the contents of the received specimen, in the same way as signature competition module 112 in the device 110. Similarly, summarizing module 144 creates a summary of the computed digital signature just like summarizing module 113 did in the device 110.

The verification information extracted by the extracting module 142 and the summary created by the summarizing module 144 are fed to matching module 145. The matching module 145 checks to see if there is a match between the verification information and the summary. If the matching is successful, then the received specimen is accepted as authentic.

Calculation of the digital signature in the signature computation module 143 always involves thresholding some computed quantity in order to generate the output bits. The proximity of the calculated quantities to the threshold this information upon the reliability of each signature bit.

The output of the summarizing module 144 function is bit-sensitive: a change in a single bits of the input results in a completely different output. Minor changes to the quality of the image 111, but not to its actual content, should not cause the image 111 to be judged as authentic by a verifier. For this reason, if there is no direct match between the verification information and the summary, the matching module 145 in a preferred embodiment signals to the signature computation module 143 that one or more unreliable bits in the computed digital signature should be flipped, e.g. changed from zero to one or vice versa.

The thusly modified signature is then fed to the summarizing module 144 so that a new summary can be computed, which in turn can then be matched against the extracted verification information. It again no match is found, the matching module 145 signals again to the signature computation module 143 that one or more other unreliable bits should be flipped, and the process is repeated once more. If all possible unreliable signature bits (or, alternatively, all possible groups of unreliable signature bits) have been tried and still no match was found, the matching module 145 concludes that the received specimen of the image 111 has been tampered with.

In a further embodiment the signature computation module 112 computes respective digital signatures over respective portions of the contents of the image 111. Consequently, the summarizing module 113 then computes respective summaries for the respective digital signatures, and the embedding module 114 embeds the respective summaries in the respective portions of the image 111. At the receiving end, the signature computation module 143 and the summarizing module 144 should do the same. The extracting module 142 should then extract the respective verification information for each of the respective portions.

This embodiment provides the ability to detect which areas of a tampered digital object have been altered. For example, in the case of a digital image, the image could be divided into respective spatial regions, and respective digital signatures could be computed for each region. The matching module 145 then matches for of the extracted respective verification information with the respective summaries. A match or definite non-match in a particular portion then establishes that that particular portion is or is not authentic.

It should be noted that the above-mentioned embodiments illustrate rather than limit the invention, and that those skilled in the art will be able to design many alternative embodiments without departing from the scope of the appended claims. The invention is not restricted to protecting and verifying the authenticity of digital images, but can equally well be applied to other digital objects, such as sound recordings or video streams.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements.

The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A method of protecting a digital object against unauthorized tampering, comprising computing a digital signature over the contents of the digital object, creating a summary of the computed digital signature, and embedding the summary in the digital object.

2. The method of claim 1, in which the digital signature is created by applying a robust hash function to the contents.

3. The method of claim 1, in which a cryptographic hash function or cyclic redundancy check is applied to the computed digital signature to create the summary.

4. The method of claim 1, in which respective digital signatures are computed over respective portions of the contents, respective summaries are computed for the respective digital signatures, and the respective summaries are embedded in the respective portions.

5. A method of verifying the authenticity of a digital object, comprising extracting verification information from the digital object, computing a digital signature over the contents of the digital object, creating a summary of the computed digital signature, and matching the verification information and the summary, whereby the digital object is verified as authentic if the matching is successful.

6. The method of claim 5, in which an unreliable portion of the computed digital signature is adjusted upon an unsuccessful matching, after which the method is repeated using the adjusted digital signature.

7. A device for protecting a digital object against unauthorized tampering, comprising signature computation means for computing a digital signature over the contents of the digital object, summarizing means for creating a summary of the computed digital signature, and embedding means for embedding the summary in the digital object.

8. A device for verifying the authenticity of a digital object, comprising extracting means for extracting verification information from the digital object, signature computation means for computing a digital signature over the contents of the digital object, summarizing means for creating a summary of the computed digital signature, and matching means for matching the verification information and the summary, whereby the matching means are arranged for verifying the digital object as authentic if the matching is successful.

9. A computer program product arranged for causing a processor to execute the method of claim 1.

10. A computer program product arranged for causing a processor to execute the method of claim 5.
